(19) United States
(12) Patent Application Publication
(10) Pub. No.: US 2020/0178698 A1
(43) Pub. Date: Jun. 11, 2020

(54) POCKETED SPRING UNIT HAVING MULTIPLE INNER SPRINGS

(71) Applicant: L&P Swiss Holding GmbH, Wittenbach (CH)

(72) Inventors: Niels Albæk, Varde (DK); Morten Jørgensen, Gram (DK)

(21) Appl. No.: 16/608,921

(22) PCT Filed: May 14, 2018
(86) PCT No.: PCT/EP2018/062364

§ 371 Date: Oct. 28, 2019

(30) Foreign Application Priority Data
May 15, 2017 (EP) 17171102.1

(51) Int. Cl. A47C 27/06; B68G 9/00

(52) U.S. Cl. CPC A47C 27/064; B68G 9/00

(57) ABSTRACT

A pocketed spring unit comprises a first pocketed spring (11), a second pocketed spring (12) arranged inside the first pocketed spring (11), and a third pocketed spring (13) arranged inside the second pocketed spring (12).

### FIELD OF THE INVENTION

Various embodiments relate to a pocketed spring unit, a pocket string, an innerspring unit, a mattress, and a method for manufacture of a pocket string. In particular, the various embodiments relate to semi-finished products or products for the bedding industry which comprise a pocketed spring unit having multiple inner springs.

### BACKGROUND OF THE INVENTION

In the bedding industry, pocketed spring units are well-known as elementary building blocks of pocket strings, innerspring units and spring mattresses.

As personal well-being and convenience are main selling points for bedding products, bedding manufacturers and suppliers are constantly striving to customize user experience.

In this regard, it is well-known in the art to provide pocketed spring units with additional inserts. For example, according to document WO 2000/045 676 A1, the springs of a pocket string may contain inserts such as foam cylinders or pocketed spring coils to impart differing degrees of firmness to different pocket strings.

However, such pocketed spring units do not impart the full potential of customization, particularly with respect to differentiated support of different body parts, or even personalization of bedding products.

### BRIEF SUMMARY OF THE INVENTION

Therefore, a need exists to provide advanced techniques for customizing user experience of bedding products which comprise pocketed spring units. In particular, a need exists for such techniques which provide additional degrees of freedom with regard to customization of bedding products for different target groups or individuals.

These underlying objects of the invention are each solved by the features of the independent claims. Preferred embodiments of the invention are set forth in the dependent claims.

According to various embodiments, a pocketed spring unit is provided. The pocketed spring unit comprises a first pocketed spring, a second pocketed spring arranged inside the first pocketed spring, and a third pocketed spring arranged inside the second pocketed spring.

In other words, the pocketed spring unit has multiple inner springs.

Each of the pocketed springs may comprise a coil spring enclosed by a fabric pocket.

A coil spring, also known as helical spring, has a spring rate which relates compression (or stretching) of the spring and force exercised by the spring.

A spring rate of an individual coil spring may be linear in case of cylindric spring designs, or nonlinear in case of other, e.g. conical, designs.

A fabric pocket may, e.g., be formed by welding or glueing sheets of an elongate fabric envelope around an outline of the enclosed coil spring which is arranged inside the fabric envelope. Forming a pocket may also be referred to as pocketing.

The pocketed springs may have a generally concentric arrangement.

A concentric arrangement of pocketed springs means that convolution axes of the pocketed springs are arranged such that the pocketed springs exercise their respective spring forces, if any, in a same direction, and that their individual spring rates sum up.

A convolution axis of a coil spring traverses the coil spring from one end face of the spring to its other end face. The convolution axis denotes a direction into which the coil spring exercises a counterforce if it experiences any compression (or stretching).

The pocketed springs may have a same spring rate or may have different spring rates.

A total spring rate of, and thus a total force exercised by, a pocketed spring unit comprising multiple inner springs corresponds to the sum of respective individual spring rates of, and forces exercised by, the pocketed springs of the pocketed spring unit.

This enables variable rate progressive performance of pocketed spring units. At an initial load (or compression), just an outer spring is being compressed at its individual spring rate. As soon as compression is such that a tallest inner spring is being engaged, required compression force increases, as a sum of individual spring rates. As a result the whole spring unit becomes firmer. This event reoccurs with each subsequently engaged internal spring. Softer response during initial compression smoothly transitions to a more firmer and supportive performance for user body mass placed on it.

Depending on the respective individual spring rates of the pocketed springs of the pocketed spring unit, the total force exercised may be a sectionally linear function of compression of the spring unit, wherein the sections may have well-defined slopes. In other words, the total spring rate as a function of spring compression may be customized according to individual needs of a user, or of groups of users.

For example, a pocketed spring unit according to an embodiment enclosing three pocketed springs results in a total spring rate having three distinguished firmnesses, which are separated by two deflection points.

Each inner of the pocketed springs may be smaller or equal in axial dimension, i.e., spring height, than each of the pocketed springs enclosing the respective inner spring.

Respective axial dimensions, i.e. heights, of pocketed springs of a pocketed spring unit provide multiple degrees of freedom in customization of a total spring rate of the pocketed spring unit. Individual pocketed springs of a pocketed spring unit only start responding, i.e. exercising a force, when they start being compressed. This means that the height of the individual pocketed springs defines the position of the deflection points of the total spring rate function in the direction of the axis of the function diagram which denotes compression of the pocketed spring unit.

Each inner of the pocketed springs may be smaller in transverse dimension, i.e., spring diameter, than each of the pocketed springs enclosing the respective inner spring.

Having a concentric arrangement (see above) and a smaller spring diameter enables enclosed pocketed springs to freely move within respective enclosing pocketed springs in a direction of a joint axis of orientation. In particular, this enables self-adjustment of pocketed spring units, regardless of which side an innerspring unit or a mattress comprising the pocketed spring unit is turned on.

According to various embodiments, a string of pocketed spring units according to an embodiment is provided. A first spring of each of the pocketed spring units may be enclosed by a respective fabric pocket which is formed in an elongate fabric envelope. The pocketed springs may be axially arranged in a transverse direction to a length direction of the fabric envelope.

A string of pocketed spring units is a semi-finished product from which innerspring units or mattresses are formed, usually in length dimension corresponding to a width or a length dimension of the respective innerspring unit or mattress.

Individual pocketed spring units of a string can have inner springs of freely selectable count, including a single spring in some of them, without any enclosed pocketed springs.

In particular, a string of pocketed spring units according to an embodiment can have pocketed spring units with multiple inner springs in a freely selectable frequency, for example, in all pocketed spring units, in every second pocketed spring unit, in every third pocketed spring unit or a combination of these.

According to an embodiment, an innerspring unit is provided. The innerspring unit may comprise a plurality of strings of pocketed spring units according to embodiments. The plurality of strings may be arranged side-by-side.

In particular, a side-by-side arrangement may be such that circumferential surfaces of the pocketed spring units of adjacent strings of the plurality of strings abut one another. The pocketed spring units of adjacent strings of the plurality of strings may be joined to each other at respective abutment surfaces.

In particular, an innerspring unit according to an embodiment can have different variants of a string, each comprising pocketed spring units having inner springs of freely selectable count, including a single spring without any enclosed pocketed springs in some of them, or a single inner spring, or multiple inner springs.

This enables limitless zoning capabilities in any spring unit direction, i.e., width or length direction of the innerspring unit, or just around the edges of the innerspring unit.

According to an embodiment, a mattress is provided, the mattress comprising an innerspring unit according to an embodiment.

According to various embodiments, a method for manufacture of a pocketed spring unit is provided. The method comprises providing a third spring; pocketing the third spring; providing a second spring; arranging the third pocketed spring inside the second spring; pocketing the second spring; providing a first spring; arranging the second pocketed spring inside the first spring; and pocketing the first spring.

The pocketed spring unit may be a pocketed spring unit according to embodiments.

In particular, pocketing may advantageously be done in the course of manufacture of a pocket string, wherein an elongate sheet of fabric may be folded such that an elongate contiguous envelope is formed in which a spring may be enclosed.

### BRIEF DESCRIPTION OF THE DRAWINGS

Embodiments of the invention will be described with reference to the accompanying drawings in which the same or similar reference numerals designate the same or similar elements.

FIG. 1 illustrates a schematic diagram of a pocketed spring unit according to an embodiment.

FIG. 2 illustrates an example for a variable spring rate F(ΔH) of the pocketed spring unit according to an embodiment as a function of compression ΔH of the pocketed spring unit.

FIG. 3 illustrates a string of pocketed spring units according to an embodiment.

FIGS. 4a and 4b illustrate innerspring units and mattresses according to various embodiments.

FIG. 5 illustrates a flowchart of a method according to various embodiments.

### DESCRIPTION OF EMBODIMENTS

Exemplary embodiments of the invention will be described with reference to the drawings. While some embodiments will be described in the context of specific fields of application, the embodiments are not limited to this field of application.

The features of the various embodiments may be combined with each other unless specifically stated otherwise.

The drawings are to be regarded as being schematic representations and elements illustrated in the drawings are not necessarily shown to scale. Rather, the various elements are represented such that their function and general purpose become apparent to a person skilled in the art.

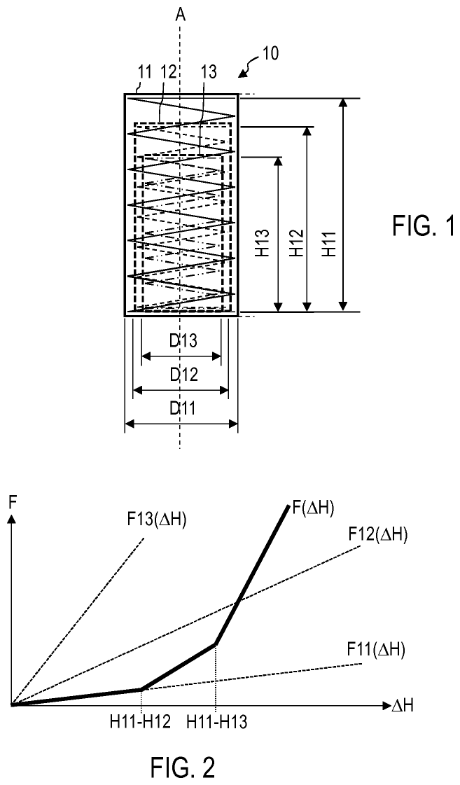

In FIG. 1, a schematic diagram of a pocketed spring unit 10 according to an embodiment is shown.

The pocketed spring unit 10 comprises pocketed springs 11, 12, 13 which have a joint axis of orientation A.

Each inner pocketed spring 12, 13 of the pocketed springs 11, 12, 13 is smaller or equal in axial dimension, i.e., in spring height, than each of the pocketed springs 11, 12 enclosing the respective inner pocketed spring 12, 13. As can be seen, the pocketed springs 11, 12, 13 have exemplary spring heights H11>H11>H12.

Further, each inner pocketed spring 12, 13 of the pocketed springs 11, 12, 13 is smaller in transverse dimension, i.e., spring diameter, than each of the pocketed springs 11, 12 enclosing the respective inner pocketed spring 12, 13. It can be taken from FIG. 1 that the pocketed springs 11, 12, 13 have exemplary spring diameters D11>D12>D13.

In FIG. 2, an example for a variable spring rate F(ΔH) of the pocketed spring unit 10 according to an embodiment is shown as a function of compression ΔH of the pocketed spring unit 10.

The pocketed springs 11, 12, 13 may have a same spring rate F11=F12=F13 or different spring rates F11, F12, F13. In FIG. 2, the latter case is illustrated.

Depending on the compression ΔH exercised on pocketed spring unit 10 and depending on the heights H11, H12, H13 of the involved pocketed springs 11, 12, 13, at an initial compression 0<ΔH<H11−H12 just an outer spring 11 is being compressed at its individual spring rate F11(ΔH), resulting in a total spring rate of F(ΔH)=F11(ΔH).

As soon as compression is such that the tallest inner spring 12 is being engaged, i.e., if H11−H12<ΔH<H11−H13, the total spring rate increases as a sum of individual spring rates F(ΔH)=F11(ΔH)+F12(ΔH−(H11−H12)). As a result, pocketed spring unit 10 becomes firmer.

This event reoccurs with each subsequently engaged internal spring 13. If H11-H13<ΔH, a total spring rate of F(ΔH)=F11(ΔH)+F12(ΔH−(H11−H12))+F13(ΔH−(H11−H13)) applies.

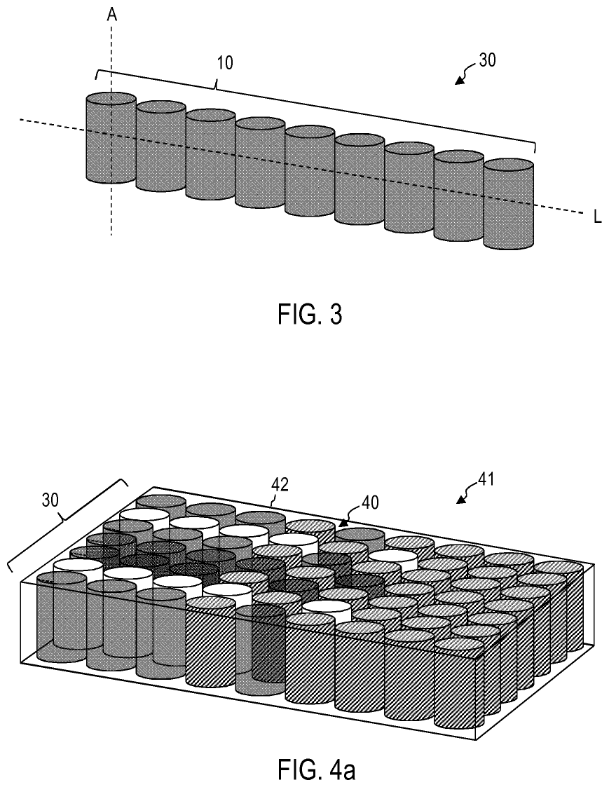

In FIG. 3, a string 30 of pocketed spring units 10 according to an embodiment is shown.

In the string 30, a respective fabric pocket formed in an elongate fabric envelope encloses a respective first spring of each of the pocketed spring units 10.

The pocketed spring units 10 are axially arranged in a transverse direction A to the length direction L of the fabric envelope.

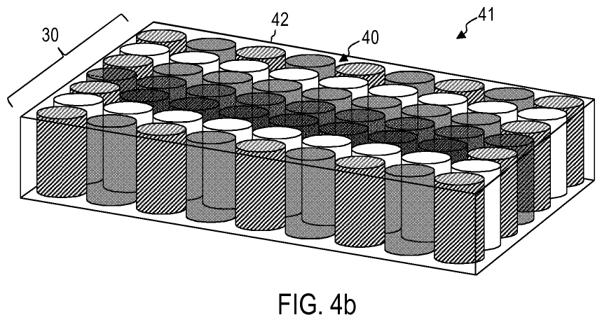

In FIGS. 4a and 4b, innerspring units 40 and mattresses 41 according to various embodiments are shown.

The innerspring units 40 comprise respective pluralities of strings 30 of pocketed spring units 10 according to embodiments. Shading is used to indicate pocketed spring units 10 according to embodiments.

The respective plurality of strings 30 is arranged side-by-side such that circumferential surfaces of the pocketed spring units 10 of adjacent strings 30 of the respective plurality of strings 30 abut one another. The pocketed spring units 10 of adjacent strings of the plurality of strings 30 may be joined to each other at respective abutment surfaces, for example by glueing.

The mattress 41 comprises an innerspring unit 40 according to an embodiment and an upholstered covering 42 encasing the innerspring unit 40.

FIG. 4a illustrates an innerspring unit 40 and a mattress 41 according to embodiments having sections of different firmness in a length direction of the respective innerspring and mattress. As can be seen, a leftmost section of innerspring unit 40 and mattress 41 comprises no pocketed spring units 10 with multiple inner springs. A middle section of innerspring unit 40 and mattress 41 comprises multiple inner springs in every second pocketed spring unit 10. In a rightmost section of innerspring unit 40 and mattress 41, every pocketed spring unit 10 has multiple inner springs.

FIG. 4b illustrates an innerspring unit 40 and a mattress 41 according to embodiments having sections of different firmness in an interior section and around the edges of the innerspring unit 40 and mattress 41. While the interior section has no pocketed spring units 10 with multiple inner springs, around the edges of the innerspring unit 40 and mattress 41, every second pocketed spring unit 10 comprises multiple inner springs.

Pocketed spring units 10 according to embodiments may be comprised in innerspring units 40 and mattresses 41 according to embodiments in accord with other patterns as well. For example, pocketed spring units 10 may be arranged in arbitrary periodic or aperiodic patterns in length, width and/or diagonal directions of the respective innerspring unit 40 and mattress 41.

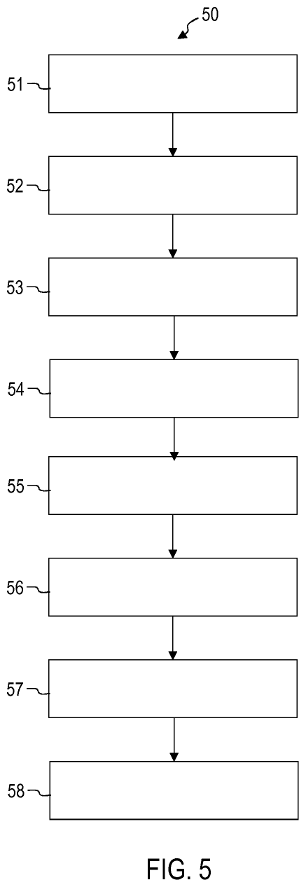

In FIG. 5, a flowchart of a method 50 according to various embodiments is shown.

Method 50 is for manufacture of a pocketed spring unit 10, which may be one of a plurality of pocketed spring units 10 in a string 30 of pocketed spring units 10.

First, at step 51, a third spring is provided.

Next, at step 52, the third spring is pocketed. For example, this may be achieved by enclosing the third spring between plies of an elongate envelope of fabric, by glueing or ultrasonic welding of the fabric plies around the outline of the enclosed spring, and by singulation of the resulting third pocketed spring 13.

At step 53, a second spring is provided. Height and diameter of the second spring are selected such that the third pocketed spring 13 may be inserted into the cavity of the second spring.

At step 54, the third pocketed spring 13 is arranged inside the second spring.

At step 55, the second spring is pocketed as in step 52, resulting in a second pocketed spring 12.

At step 56, a first spring is provided. Height and diameter of the first spring are chosen such that the second pocketed spring 12 may be inserted into the cavity of the first spring.

At step 57, the second pocketed spring 12 is arranged inside the first spring.

Finally, at step 58, the first spring is pocketed similarly as in steps 52 or 55, resulting in a first pocketed spring 11. As an option, however, singulation of the resulting pocketed spring unit 10 comprising the pocketed springs 11, 12, 13 may be omitted to obtain a string 30 of pocketed spring units 10.

Although the invention has been shown and described with respect to certain preferred embodiments, equivalents and modifications will occur to others skilled in the art upon the reading and understanding of the specification. The present invention includes all such equivalents and modifications, and is limited only by the scope of the following claims.

1-12. (canceled)

13. A pocketed spring unit, comprising
a first pocketed spring;
a second pocketed spring arranged inside the first pocketed spring; and
a third pocketed spring arranged inside the second pocketed spring.

14. The pocketed spring unit of claim 13,
wherein each of the first, second and third pocketed springs comprises a coil spring enclosed by a fabric pocket.

15. The pocketed spring unit of claim 13,
wherein the first, second and third pocketed springs are arranged in a generally concentric arrangement.

16. The pocketed spring unit of claim 13,
wherein the first, second and third pocketed springs have a same spring rate.

17. The pocketed spring unit of claim 13,
wherein the first, second and third pocketed springs have different spring rates.

18. The pocketed spring unit of claim 13,
wherein the second pocketed spring is smaller than or equal in axial dimension as the first pocketed spring; and
wherein the third pocketed spring is smaller than or equal in axial dimension as the second pocketed spring.

19. The pocketed spring unit of claim 13,
wherein the second pocketed spring is smaller in transverse dimension than the first pocketed spring; and
wherein the third pocketed spring is smaller in transverse direction than the second pocketed spring.

20. A string of pocketed spring units,
wherein each of the pocketed spring units comprises
a first pocketed spring;
a second pocketed spring arranged inside the first pocketed spring; and
a third pocketed spring arranged inside the second pocketed spring.

21. The string of pocketed spring units of claim 20,
wherein a first spring of each of the pocketed spring units is enclosed by a respective fabric pocket which is formed in an elongate fabric envelope; and
wherein the pocketed spring units are axially arranged in a direction which is transverse to a length direction of the fabric envelope.

22. An innerspring unit, comprising
a plurality of strings of pocketed spring units according to claim 20,
wherein the strings of the plurality of strings are arranged side-by-side.

23. A mattress, comprising
an innerspring unit according to claim 22.

24. A method for manufacture of a pocketed spring unit, comprising the steps:
providing a third spring;
pocketing the third spring;
providing a second spring;
arranging the third pocketed spring inside the second spring;
pocketing the second spring;
providing a first spring;
arranging the second pocketed spring inside the first spring; and
pocketing the first spring.

25. The method of claim 24,
wherein each of the first, second and third pocketed springs comprises a coil spring enclosed by a fabric pocket.

26. The method of claim 24,
wherein the first, second and third pocketed springs are arranged in a generally concentric arrangement.

27. The method of claim 24,
wherein the first, second and third pocketed springs have a same spring rate.

28. The method of claim 24,
wherein the first, second and third pocketed springs have different spring rates.

29. The method of claim 24,
wherein the second pocketed spring is smaller than or equal in axial dimension as the first pocketed spring; and
wherein the third pocketed spring is smaller than or equal in axial dimension as the second pocketed spring.

30. The method of claim 24,
wherein the second pocketed spring is smaller in transverse dimension than the first pocketed spring; and
wherein the third pocketed spring is smaller in transverse direction than the second pocketed spring.
